(19) United States
(12) Patent Application Publication
(10) Pub. No.: US 2023/0060972 A1
(43) Pub. Date: Mar. 2, 2023

(54) CHEMICALLY STRENGTHENED GLASS ARTICLE AND MANUFACTURING METHOD THEREOF

(71) Applicant: AGC Inc., Tokyo (JP)

(72) Inventors: Takumi UMADA, Tokyo (JP); Yusuke FUJIWARA, Tokyo (JP); Shusaku AKIBA, Tokyo (JP)

(73) Assignee: AGC Inc., Tokyo (JP)

(21) Appl. No.: 18/045,935

(22) Filed: Oct. 12, 2022

Related U.S. Application Data
(63) Continuation of application No. PCT/JP2021/019405, filed on May 21, 2021.

(30) Foreign Application Priority Data
May 22, 2020 (JP) 2020-089755

(51) Int. Cl. C03C 21/00; C03C 10/00

(52) U.S. Cl. CPC C03C 21/002; C03C 10/0027; C03C 2204/00

(57) ABSTRACT

The present invention relates to a chemically strengthened glass article including: a first surface; a second surface facing the first surface; and an end portion in contact with the first surface and the second surface, in which the first surface has a compressive stress value of 400 MPa to 1000 MPa, in which, when a compressive stress value of an inside of the glass is expressed with a depth from the first surface as a variable, a depth m [μm] at which the compressive stress value is maximum is larger than 0 μm, and a value of CSₘ−CS₀ [MPa] is 30 MPa or more, and in which a depth DOL at which the compressive stress value is 0 is 50 μm to 150 μm.

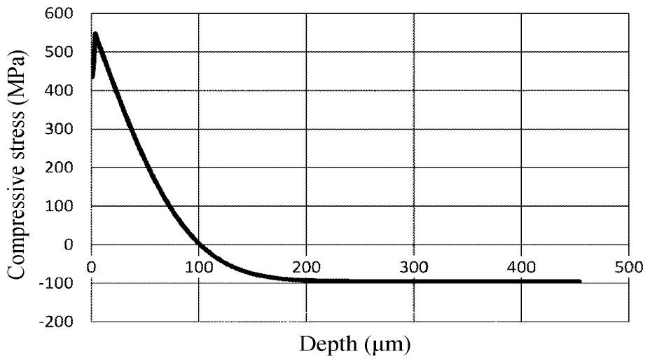

### TECHNICAL FIELD

The present invention relates to a chemically strengthened glass article and a method for producing the chemically strengthened glass article.

### BACKGROUND ART

A chemically strengthened glass is used as a cover glass or the like of a mobile terminal. The chemically strengthened glass is a glass in which a compressive stress layer is formed on a surface portion of the glass by bringing the glass into contact with a molten salt such as sodium nitrate to cause ion exchange between alkali metal ions contained in the glass and alkali metal ions that have a larger ionic radius and are contained in the molten salt. The strength of the chemically strengthened glass strongly depends on a stress profile represented by a compressive stress value with a depth from a glass surface as a variable.

A cover glass of a mobile terminal or the like may be cracked due to deformation when the cover glass drops. In order to prevent such fracture, that is, fracture caused by a bending mode, it is effective to increase a compressive stress on the glass surface. Therefore, in recent years, a high surface compressive stress of 700 MPa or more is often formed.

On the other hand, when the terminal drops on asphalt or sand, the cover glass of the mobile terminal or the like may be cracked due to collision with a protrusion. In order to prevent such fracture, that is, fracture caused by an impact mode, it is effective to increase the depth of the compressive stress layer and to form the compressive stress layer up to a deeper portion of the glass.

However, when the compressive stress layer is formed on the surface part of the glass article, a tensile stress corresponding to the compressive stress on the surface inevitably occurs in a center portion of the glass article. If the tensile stress value is too large, the glass article is cracked severely and broken pieces thereof are scattered when the glass article is fractured. Therefore, the chemically strengthened glass is designed such that a compressive stress on a surface is increased and a compressive stress layer is formed in a deeper portion, while the total amount of the compressive stress on a surface layer is not excessively increased.

Patent Literature 1 describes a method of performing two-stage chemical strengthening using an alkaline aluminum borosilicate glass containing lithium. Patent Literature 2 discloses that a chemically strengthened glass which has a high drop strength and broken pieces of which are less likely to scatter when the glass is fractured can be obtained by performing a three-stage ion exchange treatment.

### CITATION LIST

### Patent Literature

Patent Literature 1: JP-T-2013-536155

Patent Literature 2: WO 2019/004124

### SUMMARY OF INVENTION

### Technical Problem

According to the method of performing the two-stage chemical strengthening described in Patent Literature 1, a large compressive stress caused by sodium-potassium exchange may be generated in a surface portion of the glass, and a slightly small compressive stress caused by lithium-sodium exchange may be generated in a deeper portion of the glass. As a result, it is considered that both the fracture caused by the bending mode and the fracture caused by the impact mode can be prevented.

However, in the chemically strengthened glass articles described in Patent Literatures 1 and 2, a very large compressive stress is formed on the outermost surface thereof. Therefore, the balance of the stress is likely to be broken due to, for example, inadequacy in the chemical strengthening treatment, and chipping may occur. In addition, when a surface is polished in a case where a small scratch is generated during a production process of a chemically strengthened glass article, the strength of the portion may be significantly reduced.

Accordingly, an object of the present invention is to provide a chemically strengthened glass article which is excellent in strength and is hardly chipped, and broken pieces of which are prevented from scattering during fracture.

### Solution to Problem

The present invention provides a chemically strengthened glass article including:

a first surface;

a second surface facing the first surface; and

an end portion in contact with the first surface and the second surface,

in which the first surface has a compressive stress value of 400 MPa to 1000 MPa,

in which, when a compressive stress value of an inside of the glass is expressed with a depth from the first surface as a variable,

a depth m [μm] at which the compressive stress value is maximum is larger than 0 μm, and

a value of CSₘ−CS₀ [MPa] is 30 MPa or more, provided that the compressive stress value at the depth of m [μm] is defined as CSₘ [MPa], and the compressive stress value of the first surface is defined as CS₀ [MPa], and

in which a depth DOL at which the compressive stress value is 0 is 50 μm to 150 μm.

In addition, the present invention provides a method for producing a chemically strengthened glass article, the method including:

immersing a lithium aluminosilicate glass into a salt at 400° C. to 450° C. including 90 mass % or more of sodium nitrate; and

taking out the lithium aluminosilicate glass from the salt, and then holding the lithium aluminosilicate glass at 100° C. to 300° C. for 1 minute or more.

### ADVANTAGEOUS EFFECTS OF INVENTION

According to the present invention, it is possible to obtain a chemically strengthened glass article which has a high strength and is hardly chipped, and broken pieces of which are prevented from scattering during fracture.

### BRIEF DESCRIPTION OF DRAWINGS

The FIGURE shows an embodiment of a stress profile of a chemically strengthened glass article of the present invention.

### DESCRIPTION OF EMBODIMENTS

In the present specification, the expression “to” indicating a numerical range is used to include the numerical values described therebefore and thereafter as the lower limit value and the upper limit value, and hereinafter, the expression “to” in the present specification is used with the same meaning unless otherwise specified.

A stress profile can be generally measured by a method using a combination of an optical waveguide surface stress meter and a scattered light photoelastic stress meter.

It is known that a stress of a glass can be accurately measured in a short time according to the method using the optical waveguide surface stress meter. An example of the optical waveguide surface stress meter is FSM-6000 manufactured by Orihara Industrial Co., Ltd. When the FSM-6000 is combined with the auxiliary software Fsm-V, the stress can be measured with a high accuracy.

However, in principle, the optical waveguide surface stress meter can measure a stress only in a case where a refractive index decreases from a surface of a sample toward an inside thereof. In a chemically strengthened glass article, a layer obtained by substituting sodium ions inside the glass with external potassium ions has a refractive index that decreases from the surface of the sample toward the inside, and thus a stress can be measured by the optical waveguide surface stress meter. However, a stress on a layer obtained by substituting lithium ions inside the glass article with external sodium ions cannot be measured by the optical waveguide surface stress meter. Therefore, in a case where a glass article containing lithium is subjected to an ion exchange treatment using a molten salt containing sodium, a depth (D_{K}) at which a compressive stress value measured by the optical waveguide surface stress meter becomes zero is not a true depth of a compressive stress layer.

A stress can be measured regardless of refractive index distribution according to the method using the scattered light photoelastic stress meter. An example of a birefringence stress meter is SLP2000 manufactured by Orihara Industrial Co., Ltd. However, it is difficult to accurately determine a stress value in a vicinity of a glass surface by the scattered light photoelastic stress meter. Therefore, in the case where the layer obtained by substituting sodium ions inside the glass with external potassium ions is formed in the vicinity of the surface of the chemically strengthened glass, accurate stress measurement can be performed by using a combination of two kinds of measurement devices, that is, an optical waveguide surface stress meter and a scattered light photoelastic stress meter.

However, in a case where a layer obtained by substituting lithium ions inside the glass with external sodium ions is formed in the vicinity of the glass surface, it is difficult to accurately measure the stress in the vicinity of the surface by using an optical waveguide surface stress meter. In this case, the stress in the vicinity of the glass surface can be accurately measured according to a method of etching one surface of the glass to any thickness to generate a stress difference between the front and back surfaces of the chemically strengthened glass, and then measuring the warpage of the glass generated in response to the stress difference.

In the present specification, the term “chemically strengthened glass” refers to a glass after being subjected to a chemical strengthening treatment, and the term “glass for chemical strengthening” refers to a glass before being subjected to a chemical strengthening treatment. In the present specification, the term “base composition of the chemically strengthened glass” is a glass composition of the glass for chemical strengthening, and a glass composition of a portion having a depth larger than the depth of the compressive stress layer (DOL) of the chemically strengthened glass is substantially the same as the base composition of the chemically strengthened glass except for the case where an extreme ion exchange treatment is performed.

In the present specification, the glass composition is expressed in terms of mol % based on oxides unless otherwise specified, and mol % is simply expressed as “%”. In addition, in the present specification, “not substantially contained” means that an amount of a component is equal to or lower than a level of an impurity contained in a raw material or the like, that is, the component is not intentionally contained. Specifically, the amount is, for example, less than 0.1%.

### <Chemically Strengthened Glass Article>

The chemically strengthened glass article of the present invention (hereinafter, sometimes referred to as “the present strengthened glass” or “the present strengthened glass article”) has a first surface, a second surface facing the first surface, and an end portion in contact with the first surface and the second surface. The present strengthened glass article is generally in the form of a flat sheet, and may be in the form of a curved surface.

### <<Stress Profile>>

The FIGURE shows an embodiment of a stress profile of the present strengthened glass. The stress profile shown in the FIGURE shows a profile of one main surface. In the present invention, stress profiles of one main surface and the other main surface may be the same or different. In the present invention, the depth from the first surface is used as a variable to represent a compressive stress value inside a glass.

In the present strengthened glass, the compressive stress value (CS₀) of the first surface is preferably 400 MPa or more, more preferably 450 MPa or more, still more preferably 500 MPa or more, and particularly preferably 550 MPa or more. As CS₀ is increased, the “fracture caused by the bending mode” can be prevented.

On the other hand, if the compressive stress value of the surface is too large, the end portion may be chipped after chemical strengthening. This phenomenon is called chipping.

From the viewpoint of preventing this, CS₀ is preferably 1000 MPa or less, more preferably 900 MPa or less, and still more preferably 800 MPa or less.

In the stress profile of the present strengthened glass, the stress is not maximum on the glass surface in a range from the first surface to a depth of 10 μm in the thickness direction. That is, when the depth at which the compressive stress value is maximum is defined as m [μm], m>0 is satisfied. The glass surface generally includes blind scratch with a depth of several μm, and having the maximum stress at that point is most effective in preventing a crack from developing. In addition, when m>0 is satisfied, severe crushing hardly occurs during fracture, and chipping during polishing can be prevented. Therefore, the depth at which the stress is maximum is preferably 0.5 μm or more, more preferably 1 μm or more, and still more preferably 1.5 μm or more.

When the blind scratch exceeds 10 μm, commercial value decreases from the viewpoint of visibility, and thus the blind scratch of the product is generally 10 μm or less. Therefore, the depth at which the stress is maximum is preferably 10 μm or less, more preferably 9 μm or less, and still more preferably 8 μm or less.

In general, it is considered that the chemically strengthened glass can prevent the expansion of minute cracks on the glass surface and can be hardly cracked by increasing the compressive stress value of the glass surface. In addition, it is considered that by increasing the depth of the compressive stress layer and forming a compressive stress layer up to a deeper portion of the glass, the glass can be hardly cracked even when receiving a large impact.

However, when the compressive stress layer is formed on the surface of the glass, a tensile stress layer is inevitably formed inside the glass. When a value of an internal tensile stress is large, the chemically strengthened glass is severely crushed during fracture, and broken pieces thereof are likely to be scattered.

In the stress profile of the present strengthened glass, when a compressive stress value at a depth of m [μm] at which the compressive stress value is maximum is defined as CSₘ [MPa], and a compressive stress value of the first surface is defined as CS₀ [MPa], a difference between CSₘ and CS₀ (CSₘ−CS₀) is 30 MPa or more, preferably 35 MPa or more, more preferably 40 MPa or more, still more preferably 45 MPa or more, and particularly preferably 50 MPa or more.

When (CSₘ−CS₀) is 30 MPa or more, severe crushing hardly occurs during fracture, and chipping during polishing can be prevented. When the total amount of compressive stress is too large, severe crushing occurs when receiving damage. On the other hand, from the viewpoint of preventing bending fracture (CSₘ−CS₀) is preferably 300 MPa or less, more preferably 280 MPa or less, still more preferably 250 MPa or less, particularly preferably 200 MPa or less.

In the stress profile of the present strengthened glass, the depth DOL at which the compressive stress value is 0 is preferably 50 μm or more, more preferably 60 μm or more, still more preferably 70 μm or more, and particularly preferably 80 μm or more. When the DOL is 50 μm or more, a compressive stress is introduced into a relatively deep portion of the glass in the sheet thickness direction, which is advantageous for prevention of a crack caused by collision. When the DOL is too large, the internal tensile stress becomes too large. Therefore, the DOL is preferably 150 μm or less, more preferably 135 μm or less, still more preferably 130 μm or less, and particularly preferably 125 μm or less.

The sheet thickness (t) of the present strengthened glass article is preferably 300 μm or more, more preferably 500 μm or more, still more preferably 600 μm or more, still more preferably 700 μm or more, and particularly preferably 800 μm or more. As t is increased, a crack hardly occurs. In the case where the present strengthened glass article is used for a mobile terminal or the like, t is preferably 2000 μm or less, and more preferably 1000 μm or less in order to reduce the weight.

The depth of the compressive stress layer (DOL) of the present strengthened glass is preferably 0.1 t or more, more preferably 0.11 t or more, and still more preferably 0.12 t or more. When the DOL is 0.1 t or more, a compressive stress is introduced into a relatively deep portion of the glass in the sheet thickness direction, which is advantageous for prevention of a crack caused by collision. In order to balance the total amount of the compressive stress and the tensile stress over the entire thickness direction of the glass, the DOL is preferably 0.25 t or less, more preferably 0.23 t or less, and still more preferably 0.2 t or less.

In the stress profile of the present strengthened glass, the compressive stress value CS₆₀ at a depth of 60 μm from the first surface is preferably 100 MPa or more, more preferably 110 MPa or more, still more preferably 120 MPa or more, and particularly preferably 130 MPa or more.

When a glass article drops on an asphalt-paved road or sand, a crack occurs due to collision with a protrusion such as sand. The length of the occurred crack varies depending on the size of the sand with which the glass article collides, but when the compressive stress value CS₆₀ is 100 MPa or more, a stress profile in which a large compressive stress value is formed in the vicinity of a depth of 60 μm is formed, and thus fracture caused by an impact mode in which the glass article collides with a relatively large protrusion and is crushed can be prevented.

On the other hand, when a large compressive stress layer is formed inside the glass, the tensile stress value corresponding to the compressive stress of the surface inevitably increases in a center portion of the glass. If the tensile stress value is too large, the glass article is severely cracked and broken pieces thereof are scattered when the glass article is fractured. Therefore, the compressive stress value CS₆₀ is preferably 200 MPa or less, and more preferably 150 MPa or less. The compressive stress value herein is a value measured by a birefringence stress meter. In a case where CS₆₀ is within the above range, the thickness t of the glass is preferably 300 μm or more.

In order to increase the drop strength on asphalt, the compressive stress value CS₅₀ at a depth of 50 μm from the first surface is preferably 100 MPa or more, more preferably 140 MPa or more, and still more preferably 160 MPa or more.

In the stress profile of the present strengthened glass, a tensile stress value CT at a depth (0.5×t) μm from the first surface of the glass article is preferably 120 MPa or less, more preferably 110 MPa or less, and still more preferably 100 MPa or less. Accordingly, severe crushing hardly occurs. Here, the depth (0.5×t) μm corresponds to the center portion of the glass in the thickness direction, and a tensile stress value at this depth means a value of the tensile stress inside the glass.

In addition, in order to provide sufficient strengthening that makes the glass article hardly crack at the time of dropping, the tensile stress value at the depth (0.5×t) μm from the first surface of the glass article is preferably 50 MPa or more, and more preferably 75 MPa or more.

The present strengthened glass preferably includes lithium aluminosilicate glass. Regarding the lithium aluminosilicate glass, ion exchange can be efficiently performed using a salt containing sodium, and a large compressive stress caused by sodium-potassium exchange can be introduced into a surface portion of the glass. In addition, a slightly small compressive stress caused by lithium-sodium exchange can be introduced into a portion deeper than the glass surface. Therefore, it is said that both the fracture caused by the bending mode and the fracture caused by the impact mode due to the collision with the protrusion can be prevented.

### <<Glass Composition>>

In the present strengthened glass, the glass composition in the central portion in the sheet thickness direction, that is, the glass composition of the base glass of the chemically strengthened glass preferably includes, in terms of mol % based on oxides: SiO₂ in an amount of 40% to 75%, Al₂O₃ in an amount of 2% to 35%, and Li₂O in an amount of 4% to 35%.

Since the glass composition in the central portion in the thickness direction is substantially the same as the composition of the glass for chemical strengthening, the details of the preferable glass composition will be described in the item of <glass for chemical strengthening>.

In one aspect, when the thickness is defined as t [μm] and the ion concentrations of Li, Na, and K at a depth of x [μm] from the first surface are defined as Li(x), Na(x), and K(x), the present strengthened glass preferably satisfies Li(0)≤Li(t/2) and K(0)≤K(t/2). That is, the K ion concentration of the outermost surface is preferably equal to or lower than the internal concentration. In addition, it is preferable that Na(0)>0.3×[Li(0)+Na(0)+K(0)] is satisfied, and Li(t/2)>0.7×[Li(t/2)+Na(t/2)+K(t/2)] is satisfied.

The chemically strengthened glass obtained by subjecting the lithium aluminosilicate glass to a two-stage ion exchange treatment may have lower weather resistance than the glass before chemical strengthening. This is presumably because a large number of potassium ions present on the glass surface chemically react with components in the air to generate precipitates. In the aspect, the K ion concentration of the outermost surface is equal to or lower than the internal concentration, so that a chemical reaction with components in the air is prevented, and thus excellent weather resistance is exhibited. It is indicated that potassium ions on the outermost surface are exchanged with the sodium ions in the molten salt, only the stress on the surface can be reduced.

The ion concentration of the glass surface can be measured by an EPMA (Electron Probe Micro Analyzer).

The weather resistance of the chemically strengthened glass can be evaluated by a weather resistance test. The chemically strengthened glass of the present invention preferably has a haze-value change rate, between before and after standing at 80° C. for 120 hours at a humidity of 80%, of 5% or less, more preferably 4% or less, and still more preferably 3% or less. The haze value is determined by measuring a haze value at a C light source using a haze meter.

### <Glass Ceramics>

The present strengthened glass may be glass ceramics. In a case where the present strengthened glass is glass ceramics, it is preferable that the visible light transmittance in terms of a thickness of 0.7 mm is 85% or more because a screen of a display is easily visible in a case where the strengthened glass is used as a cover glass of a mobile display. The visible light transmittance in terms of a thickness of 0.7 mm is more preferably 88% or more, and still more preferably 90% or more.

The visible light transmittance is measured in accordance with JIS R 3106: 2019. In the present specification, the term “light transmittance” refers to an average transmittance for light having a wavelength of 380 nm to 780 nm. In a case where the thickness of the chemically strengthened glass is not 0.7 mm, the transmittance in the case of 0.7 mm can be calculated from the measured transmittance applying Lambert-Beer law.

In a case where the present strengthened glass is glass ceramics, the haze value in terms of a thickness of 0.7 mm is preferably 0.5% or less, more preferably 0.4% or less, and still more preferably 0.3% or less. When the haze value is 0.5% or less, the visibility of the screen of the display is improved when the strengthened glass is used as a cover glass or the like of a mobile display. The haze value is measured using a C light source in accordance with JIS K3761: 2000.

In a case where the total visible light transmittance of the glass ceramics having a sheet thickness t [mm] is 100×T [%], and the haze value is 100×H [%], T=(1−R)²×exp (−αt) can be established using a constant a by applying Lambert-Beer law. Using this constant α, dH/dt∞exp(−αt)×(1−H)

The haze value H_{0.7} in the case of 0.7 mm is determined by the following formula.

H_{0.7}=100×[1−(1−H)^{{((1-R)}^{²}^{-T}^{_{0.7}}^{)/(1-R)}^{²}^{-T)}}][%] [Formula 1]

In the case where the present strengthened glass is glass ceramics, the kind of the contained crystal is basically the same as that of the glass before chemical strengthening, and thus the kind of the contained crystal will be described in the item of the glass for chemical strengthening. A crystal containing an alkali metal component may change due to the chemical strengthening treatment in the vicinity of the surface of the strengthened glass. It is considered that this is because the alkali metal ions contained in the crystal are subjected to ion exchange.

The shape of the present strengthened glass of the present invention may be a shape other than a sheet shape depending on a product or a use to be applied, or the like. In addition, the glass sheet may have an edged shape in which the thicknesses of an outer periphery are different. In addition, the form of the glass sheet is not limited to this example, and for example, two main surfaces may not be parallel to each other, and all or a part of one or both of the two main surfaces may be curved surfaces. More specifically, the glass sheet may be, for example, a flat sheet-shaped glass sheet having no warpage or a curved glass sheet having a curved surface.

The present strengthened glass is particularly useful as a cover glass used for a mobile device such as a mobile phone and a smartphone. Further, the strengthened glass is also useful for a cover glass of a display device such as a television, a personal computer, and a touch panel, an elevator wall surface, or a wall surface (full-screen display) of a construction such as a house and a building, which are not intended to be carried. The strengthened glass is also useful as a building material such as a window glass, a table top, an interior of an automobile, an airplane, or the like, and a cover glass thereof, or a casing having a curved surface shape.

### <Method of Producing Chemically Strengthened Glass Article>

The present strengthened glass can be produced by subjecting the later-described glass for chemical strengthening to an ion exchange treatment. The glass for chemical strengthening can be produced using, for example, a general glass production method as described below.

A glass raw material is appropriately prepared, and the glass raw material is then heated and melted in a glass melting furnace so as to obtain glass having a preferable composition. Thereafter, the glass is homogenized by performing bubbling, stirring, addition of a refining agent, or the like, and formed into a glass sheet having a predetermined thickness, and the glass sheet is slowly cooled. Alternatively, the glass may be formed into a sheet shape by a method of forming the glass into a block shape, gradually cooling the block-shaped glass, and then cutting the block-shaped glass.

Examples of the method for forming the glass into a sheet shape include a float method, a press method, a fusion method, and a down-draw method. In particular, when a large-sized glass sheet is produced, the float method is preferable. Further, a continuous forming method other than the float method, for example, a fusion method and a down-draw method are also preferable.

A glass ribbon obtained by forming is subjected to grinding and polishing treatments as necessary to form a glass sheet. It is preferable to cut the glass sheet into a predetermined shape and size or, if chamfering is performed, chamfer the glass sheet before the chemical strengthening treatment to be described later because if the glass sheet is cut or chamfered before the chemical strengthening treatment is performed, a compressive stress layer is also formed on the end surface by the chemical strengthening treatment. The chemical strengthening treatment is performed on the formed glass sheet, followed by performing washing and drying to finally obtain a chemically strengthened glass.

In the case where the chemically strengthened glass is glass ceramics, the glass sheet is cut into a predetermined shape, and then the glass having the predetermined shape is crystallized by a heat treatment. The crystallization treatment may be a two-stage heat treatment.

The chemical strengthening treatment is a treatment in which, by a method of immersing glass into a melt of a metal salt (for example, potassium nitrate) containing metal ions (typically, sodium ions or potassium ions) having a large ionic radius, the glass is brought into contact with the metal salt, and metal ions having a small ionic radius (typically, lithium ions or sodium ions) in the glass and the metal ions having a large ionic radius (typically, sodium ions or potassium ions for lithium ions, and potassium ions for sodium ions) in the metal salt are substituted with each other.

The method of using “Li−Na exchange” in which lithium ions in glass are exchanged with sodium ions is particularly preferable because the speed of the chemical strengthening treatment is fast. In addition, in order to form a large compressive stress by ion exchange, “Na—K exchange” in which sodium ions in glass are exchanged with potassium ions may be used.

Examples of the molten salt for performing the chemical strengthening treatment include a nitrate, a sulfate, a carbonate, a chloride, and the like. Among them, examples of the nitrate include lithium nitrate, sodium nitrate, potassium nitrate, cesium nitrate, silver nitrate, and the like. Examples of the sulfate include lithium sulfate, sodium sulfate, potassium sulfate, cesium sulfate, silver sulfate, and the like. Examples of the carbonate include lithium carbonate, sodium carbonate, potassium carbonate, and the like. Examples of the chloride include lithium chloride, sodium chloride, potassium chloride, cesium chloride, silver chloride, and the like. One of these molten salts may be used alone, or a plurality thereof may be used in combination.

In the present invention, a molten salt containing sodium nitrate is preferably used. The content of sodium nitrate in the molten salt is preferably 90 mass % or more, more preferably 95 mass % or more, and still more preferably 98 mass % or more.

As for treatment conditions of the chemical strengthening treatment, the time, the temperature, and the like may be appropriately selected in consideration of the glass composition, the kind of the molten salt, and the like. Specifically, the present strengthened glass can be produced by, for example, a strengthening treatment method described below (hereinafter, referred to as “the present strengthening treatment method”).

The present strengthening treatment method includes a step of immersing the glass sheet into a sodium nitrate-containing strengthening molten salt (hereinafter, also referred to as a sodium-containing strengthening salt). Through this step, a high compressive stress layer can be formed in the deep layer portion of the glass. A compressive stress formed in the vicinity of the first surface and a compressive stress formed in the vicinity of the second surface facing the first surface are approximately the same.

In the sodium-containing strengthening salt, the content of sodium ions is preferably 90 mass % or more, and more preferably 95 mass % or more, when the mass of the metal ions contained in the strengthening salt is 100 mass %. The sodium-containing strengthening salt may contain lithium ions, but in order to obtain a sufficient compressive stress, the content of lithium ions is preferably 2 mass % or less, and more preferably 1 mass % or less.

In addition, in a case where the glass sheet is glass ceramics or a high-strength glass containing 20 mol % or more of Al₂O₃, the stress on the surface is less likely to decrease when the molten salt contains potassium ions. In this case, the content of the potassium ions is preferably 2 mass % or less, and more preferably 1 mass % or less. On the other hand, in a case where the glass sheet is glass other than the above glass, potassium ions may be contained in a sodium-containing strengthening salt in the first stage of two-stage strengthening in order to sufficiently reduce a bending stress of the glass which is generated in the impact caused by dropping. The content of the potassium ions in the sodium-containing strengthening salt is generally 50% or less, when the mass of metal ions contained in the strengthening salt is 100 mass %. In addition, in the case of performing the two-stage strengthening, it is recommended that lithium ions are contained in a potassium-containing strengthening salt in the second stage of the two-stage strengthening. Accordingly, the sodium ions introduced in the vicinity of the surface in the first stage and the lithium ions in the molten salt are exchanged with each other, and the stress on the surface can be weakened. At this time, the content of the lithium ions is preferably 0.2 mass % or more, and more preferably 0.4 mass % or more. In addition, the content is preferably 2 mass % or less, and more preferably 1.5 mass % or more.

In the present strengthening treatment method, the glass sheet is preferably immersed in the sodium-containing strengthening salt at 380° C. to 450° C. When the temperature of the sodium-containing strengthening salt is 380° C. or higher, ion exchange is likely to proceed. The temperature is more preferably 400° C. or higher, and still more preferably 420° C. or higher. The temperature of the sodium-containing strengthening salt is generally 450° C. or lower from the viewpoint of the risk of evaporation and a change in a composition of the molten salt.

It is preferable that the time for which the glass sheet is immersed in the sodium-containing strengthening salt is 0.5 hours or longer because the surface compressive stress increases. The immersion time is more preferably 1 hour or longer. When the immersion time is too long, not only the productivity decreases, but also the compressive stress may decrease due to a relaxation phenomenon. Therefore, the immersion time is generally 20 hours or shorter.

Next, the present strengthening treatment method includes a step of holding the glass article taken out from the sodium-containing salt at a predetermined temperature for a certain period of time. Through this step, Na ions introduced from the sodium-containing strengthening salt into the glass are thermally diffused in the glass to form a more preferable stress profile, thereby increasing the drop strength on asphalt.

The holding temperature is preferably 100° C. or higher, more preferably 130° C. or higher, and still more preferably 150° C. or higher, from the viewpoint of improving the drop strength on asphalt. When the holding temperature is too high, the diffusion of alkali ions proceeds, and the stress in the vicinity of the surface becomes too small. Therefore, the holding temperature is preferably 300° C. or lower, more preferably 280° C. or lower, and still more preferably 250° C. or lower.

In order to improve the drop strength on asphalt, the holding time is preferably 1 minute or longer, more preferably 0.2 hours or longer, still more preferably 0.3 hours or longer, and particularly preferably 0.5 hours or longer. When the holding time is too long, relaxation proceeds too much, and the stress in the vicinity of the surface becomes too small. Therefore, the holding time is preferably 4 hours or shorter, more preferably 3 hours or shorter, and still more preferably 2 hours or shorter.

The present strengthened glass may be produced by a two-stage or three-stage chemical strengthening treatment. In a case where the two-stage or three-stage strengthening treatment is performed, the total treatment time is preferably 10 hours or shorter, more preferably 5 hours or shorter, and still more preferably 3 hours or shorter, from the viewpoint of a production efficiency. On the other hand, in order to obtain a desired stress profile, the total treatment time is preferably 0.5 hours or longer, more preferably 1 hour or longer, and still more preferably 1.5 hours or longer.

### <Glass for Chemical Strengthening>

The glass for chemical strengthening in the present invention (hereinafter, sometimes referred to as the present glass for strengthening) is preferably a lithium aluminosilicate glass. More specifically, it is preferable to contain, in terms of mol% based on oxides, SiO₂ in an amount of 40% to 75%, Al₂O₃ in an amount of 2% to 35%, and Li₂O in an amount of 4% to 35%.

A glass having the above composition easily forms a preferable stress profile by the chemical strengthening treatment. The present glass for strengthening may be a glass ceramic or an amorphous glass.

In a case where the glass for chemical strengthening is a glass ceramic, a glass ceramic containing one or more crystals selected from the group consisting of lithium silicate crystals, lithium aluminosilicate crystals, and lithium phosphate crystals is preferable. The lithium silicate crystal is preferably a lithium metasilicate crystal, a lithium disilicate crystal, or the like. The lithium phosphate crystal is preferably a lithium orthophosphate crystal or the like. The lithium aluminosilicate crystal is preferably a β-spodumene crystal, a petalite crystal, or the like.

The crystallization rate of the glass ceramic is preferably 10% or more, more preferably 15% or more, still more preferably 20% or more, and particularly preferably 25% or more in order to increase the mechanical strength. In order to increase transparency, the crystallization rate is preferably 70% or less, more preferably 60% or less, and particularly preferably 50% or less. A small crystallization rate is excellent also in that it is easy to perform bending or the like by heating.

The crystallization rate can be calculated from the X-ray diffraction intensity by the Rietveld method. The Rietveld method is described in “Crystal Analysis Handbook” (published by Kyoritsu Shuppan, 1999, p492 to 499) edited by the Editorial Committee of the “Crystal Analysis Handbook” of the Crystallographic Society of Japan.

The average grain size of precipitated crystals of the glass ceramic is preferably 300 nm or less, more preferably 200 nm or less, still more preferably 150 nm or less, and particularly preferably 100 nm or less in order to increase transparency. The average grain size of the precipitated crystals can be determined from a transmission electron microscope (TEM) image. In addition, it can be estimated from a scanning electron microscope (SEM) image.

In the case where the glass for chemical strengthening is glass ceramics, as an aspect, glass obtained by subjecting an amorphous glass having the following glass composition to a heat treatment is preferable. The following glass composition is a glass composition that can be crystallized by an appropriate heat treatment. In this case, the heat treatment is preferably performed in two stages in which the temperature is increased from room temperature to a first treatment temperature, and the amorphous glass is held for a certain period of time, and then the amorphous glass is held for a certain period of time at a second treatment temperature that is higher than the first treatment temperature. The heat treatment may be performed in one stage in which crystallization is performed by holding the amorphous glass at a constant treatment temperature.

The amorphous glass contains, in terms of mol % based on oxides, SiO₂ in an amount of 40% to 75%, Al₂O₃ in an amount of 2% to 15%, Li₂O in an amount of 4% to 35%, P₂O₅ in an amount of 0% to 4%, Na₂O in an amount of 0% to 7%, and K₂O in an amount of 0% to 5%.

By heat-treating the glass having the above composition, a glass ceramic containing any one of β-spodumene crystals, petalite crystals, lithium metasilicate crystals, lithium disilicate crystals, and lithium orthophosphate crystals can be obtained. This glass preferably contains SnO₂, ZrO₂, and TiO₂ in a total amount of 1% to 7%, and more preferably contains ZrO₂ in an amount of 2% to 5% in order to promote crystallization caused by the heat treatment.

When the glass for chemical strengthening is an amorphous glass, for example, it is preferable to contain, in terms of mol % based on oxides, SiO₂ in an amount of 40% to 65%, Al₂O₃ in an amount of 15% to 35%, Li₂O in an amount of 4% to 15%, and one or both of Y₂O₃ and La₂O₃ in a total amount of 1% to 15%. Such glass has a large fracture toughness value, and a very high strength obtained by the chemical strengthening.

Alternatively, glass containing, in terms of mol % based on oxides, SiO₂ in an amount of 60% to 75%, Al₂O₃ in an amount of 8% to 20%, Li₂O in an amount of 5% to 20%, and one or both of Na₂O and K₂O in a total amount of 1% to 15% is preferable. The glass has excellent strengthening properties and is suitable for mass production such as a float method.

Hereinafter, the preferable glass composition will be described.

SiO₂ is a component constituting a glass network. In addition, SiO₂ is a component that increases chemical durability, and is a component that reduces the occurrence of cracks in a case where the glass surface is scratched. The content of SiO₂ is preferably 40% or more, more preferably 45% or more, still more preferably 48% or more, and yet still more preferably 50% or more.

In a case where the content of Al₂O₃ is about 20% or less, the content of SiO₂ is preferably 60% or more, and more preferably 64% or more in order to prevent the occurrence of cracks.

In order to increase the meltability of the glass, the content of SiO₂ is preferably 75% or less, more preferably 72% or less, and still more preferably 70% or less.

In order to obtain an amorphous glass having a particularly large fracture toughness value, the content of SiO₂ is preferably 65% or less, more preferably 62% or less, and still more preferably 60% or less.

Al₂O₃ is an effective component for improving the ion exchangeability during chemical strengthening and increasing the surface compressive stress after strengthening, and is also a component for increasing the glass transition temperature (Tg) and increasing the Young's modulus. The content of Al₂O₃ is preferably 2% or more, more preferably 5% or more, and still more preferably 10% or more.

In a case where the present strengthened glass is a glass ceramic containing lithium silicate crystals or lithium phosphate crystals, the content of Al₂O₃ is preferably 15% or less, more preferably 13% or less, and still more preferably 10% or less. In a case where the glass ceramic contains lithium aluminosilicate crystals, the content of Al₂O₃ is preferably 5% or more, more preferably 7% or more, and still more preferably 16% or more.

In order to obtain an amorphous glass having a particularly large fracture toughness value, the content of Al₂O₃ is preferably 15% or more, more preferably 18% or more, and still more preferably 20% or more.

In addition, the content of Al₂O₃ is preferably 35% or less, more preferably 30% or less, still more preferably 28% or less, and yet still more preferably 25% or less in order to increase the meltability.

For example, in order to obtain a glass ceramic containing lithium phosphate crystals or lithium silicate but not containing lithium aluminosilicate crystals, the content of Al₂O₃ is preferably 15% or less, and more preferably 12% or less.

Li₂O is a component for forming a surface compressive stress by ion exchange, and is an essential component of a lithium aluminosilicate glass. By chemically strengthening the lithium aluminosilicate glass, a chemically strengthened glass having a preferable stress profile can be obtained. The content of Li₂O is preferably 2% or more, more preferably 4% or more, still more preferably 5% or more, particularly preferably 7% or more, in order to increase the depth of the compressive stress layer DOL.

In the case of a glass ceramic containing lithium silicate or lithium phosphate, the content of Li₂O is preferably 10% or more, and more preferably 15% or more in order to sufficiently precipitate crystals.

In addition, in order to prevent the occurrence of devitrification in the production of the glass, the content of Li₂O is preferably 35% or less, more preferably 32% or less, and still more preferably 30% or less.

In a case where the present strengthened glass is an amorphous glass, the content of Li₂O is preferably 20% or less, more preferably 16% or less, and still more preferably 15% or less in order to prevent crystallization during the melting.

K₂O is a component for improving the meltability of the glass, and is also a component for improving the workability of the glass. In a case where a single-stage chemical strengthening is performed with a NaNO3 molten salt, the surface stress is likely to be reduced. K₂O may not be contained, but the content in the case of containing K₂O is preferably 0.5% or more, and more preferably 1% or more.

In a case where the content of K₂O is too large, a tensile stress may be generated due to the ion exchange treatment, and cracks may be generated. In order to prevent cracks, the content of K₂O is preferably 10% or less, more preferably 8% or less, still more preferably 6% or less, and particularly preferably 5% or less.

In a case where the present strengthened glass is a glass ceramic, the content of K₂O is preferably 5% or less, more preferably 4% or less, and still more preferably 2% or less in order to facilitate precipitation of crystals such as lithium silicate.

Na₂O is a component for forming a surface compressive stress layer by ion exchange using a molten salt containing potassium, and is a component for improving the meltability of the glass. The content of Na₂O is preferably 0.5% or more, more preferably 1% or more, and still more preferably 1.5% or more.

The content of Na₂O is preferably 10% or less, more preferably 8% or less, and still more preferably 6% or less.

In a case where the present strengthened glass is a glass ceramic, the content of Na₂O is preferably 5% or less, more preferably 4% or less, and still more preferably 3% or less in order to facilitate precipitation of crystals such as lithium silicate.

Both Na₂O and K₂O are a component for lowering the melting temperature of a glass, and are contained in a total amount of preferably 1% or more, and more preferably 2% or more, in order to prevent crystallization during the melting of a lithium aluminosilicate glass.

MgO, CaO, SrO, and BaO are all components for increasing the meltability of a glass, but tend to lower an ion exchange performance.

The total content of MgO, CaO, SrO, and BaO (MgO+CaO+SrO+BaO) is preferably 15% or less, more preferably 10% or less, and still more preferably 5% or less.

In the case of glass ceramics containing lithium silicate, lithium phosphate, or lithium aluminosilicate, the total content of (MgO+CaO+SrO+BaO) is preferably 4% or less, more preferably 3% or less, and still more preferably 2% or less in order to facilitate precipitation of crystals.

MgO, CaO, SrO, and BaO may not be contained, and the total content (MgO+CaO+SrO+BaO) in a case where at least one of these is contained is preferably 0.1% or more, and more preferably 0.5% or more. In the case where the present strengthened glass is an amorphous glass and any one of these is contained, MgO is preferably contained in order to increase the strength of the chemically strengthened glass.

In a case where MgO is contained, the content of MgO is preferably 0.1% or more, and more preferably 0.5% or more. In order to improve the ion exchange performance, the content of MgO is preferably 10% or less, and more preferably 8% or less.

In a case where CaO is contained, the content of CaO is preferably 0.5% or more, and more preferably 1% or more. In order to improve the ion exchange performance, the content of CaO is preferably 5% or less, and more preferably 3% or less.

In a case where SrO is contained, the content of SrO is preferably 0.5% or more, and more preferably 1% or more. In order to improve the ion exchange performance, the content of SrO is preferably 5% or less, and more preferably 3% or less.

In a case where BaO is contained, the content of BaO is preferably 0.5% or more, and more preferably 1% or more. In order to improve the ion exchange performance, the content of BaO is preferably 5% or less, more preferably 1% or less, and it is still more preferable that BaO is not substantially contained.

ZnO is a component for improving the meltability of a glass, and may be contained. In a case where ZnO is contained, the content of ZnO is preferably 0.2% or more, and more preferably 0.5% or more. In order to increase the weather resistance of glass, the content of ZnO is preferably 5% or less, and more preferably 3% or less.

TiO₂ is a component for increasing a surface compressive stress due to ion exchange, and may be contained. In a case where TiO₂ is contained, the content of TiO₂ is preferably 0.1% or more. The content of TiO₂ is preferably 5% or less, more preferably 1% or less, and it is still more preferable that TiO₂ is not substantially contained, in order to prevent devitrification during melting.

ZrO₂ is a component for increasing a surface compressive stress due to ion exchange, and may be contained. In a case where ZrO₂ is contained, the content of ZrO₂ is preferably 0.5% or more, and more preferably 1% or more. In order to prevent devitrification during melting, the content of ZrO₂ is preferably 5% or less, and more preferably 3% or less.

In a case where the present strengthened glass is glass ceramics, the content of ZrO₂ is preferably 2% or more, and more preferably 3% or more in order to promote crystal precipitation.

In addition, as TiO₂, ZrO₂, and SnO₂ easily promote crystallization, the total content (TiO₂+SnO₂+ZrO₂) is preferably 7% or less, more preferably 5% or less, and still more preferably 3% or less. The glass ceramic preferably contains any one of TiO₂, ZrO₂, and SnO₂. In a case where TiO₂, ZrO₂, and SnO₂ are contained, the total content of TiO₂, ZrO₂, and SnO₂ is preferably 1% or more.

Y₂O₃ is a component for improving the strength of a glass, and may be contained. In a case where Y₂O₃ is contained, the content of Y₂O₃ is preferably 0.2% or more, more preferably 0.5% or more, still more preferably 1% or more, yet still more preferably 1.5% or more, and particularly preferably 2% or more. In order to make the glass less apt to be devitrified during melting and prevent the quality of the chemically strengthened glass from deteriorating, the content of Y₂O₃ is preferably 10% or less, more preferably 8% or less, still more preferably 7% or less, even more preferably 6% or less, yet still more preferably 5% or less, particularly preferably 4% or less, and most preferably 3% or less.

La₂O₃ and Nb₂O₅ are components for preventing crushing of a glass article in a case of being chemically strengthened, and may be contained. In a case where these components are contained, the content of each of La₂O₃ and Nb₂O₅ is preferably 0.5% or more, more preferably 1% or more, still more preferably 1.5% or more, and particularly preferably 2% or more.

The total content of Y₂O₃, La₂O₃, and Nb₂O₅ is preferably 10% or less, more preferably 9% or less, and still more preferably 8% or less. Accordingly, it is possible to make the glass less apt to be devitrified during melting and prevent the quality of the chemically strengthened glass from deteriorating. The content of each of La₂O₃ and Nb₂O₅ is preferably 10% or less, more preferably 7% or less, still more preferably 6% or less, yet still more preferably 5% or less, particularly preferably 4% or less, and most preferably 3% or less.

B₂O₃ can be added for the purpose of, for example, improving the meltability during glass production. In order to reduce a slope of a stress profile in a vicinity of a surface of a chemically strengthened glass, the content of B₂O₃ is preferably 0.5% or more, more preferably 1% or more, and still more preferably 2% or more.

B₂O₃ is a component that easily causes stress relaxation after chemical strengthening, so that the content of B₂O₃ is preferably 10% or less, more preferably 8% or less, still more preferably 5% or less, and most preferably 3% or less in order to prevent a decrease in a surface compressive stress due to stress relaxation.

P₂O₅ may be contained in order to improve the ion exchange performance. In a case where P₂O₅ is contained, the content of P₂O₅ is preferably 0.5% or more, and more preferably 1% or more. In order to increase the chemical durability, the content of P₂O₅ is preferably 10% or less, more preferably 5% or less, and still more preferably 3% or less. The glass ceramic preferably contains P₂O₅ in order to promote crystal precipitation, and P₂O₅ is an essential component for the glass ceramic containing lithium phosphate.

When the glass is colored, a coloring component may be added within a range that does not inhibit the achievement of desired chemical strengthening properties. Examples of the coloring component include Co₃O₄, MnO₂, Fe₂O₃, NiO, CuO, Cr₂O₃, V₂O₅, Bi₂O₃, SeO₂, CeO₂, Er₂O₃, and Nd₂O₃. These components may be used alone or in combination.

The total content of the coloring component is preferably 7% or less. Accordingly, devitrification of the glass can be prevented. The content of the coloring component is more preferably 5% or less, still more preferably 3% or less, and particularly preferably 1% or less. In a case where it is desired to increase the visible light transmittance of glass, it is preferable that these components are not substantially contained.

In addition, SO₃, a chloride, a fluoride, or the like may be appropriately contained as a refining agent during melting of a glass. It is preferable that As₂O₃ is not substantially contained. In a case where Sb₂O₃ is contained, the content of Sb₂O₃ is preferably 0.3% or less, more preferably 0.1% or less, and it is most preferable that Sb₂O₃ is not substantially contained.

In a case where the glass having the above composition is crystallized, it is preferable to perform a two-stage heat treatment.

In the case of the two-stage heat treatment, the first treatment temperature is preferably a temperature range in which the crystal nucleation rate is large for the glass composition, and the second treatment temperature is preferably a temperature range in which the crystal growth rate is large for the glass composition. The holding time at the first treatment temperature is preferably kept long so that a sufficient number of crystal nuclei are generated. When a large number of crystal nuclei are formed, the size of each crystal is reduced, and a glass ceramic having high transparency is obtained.

The first treatment temperature is, for example, 550° C. to 800° C., and the second treatment temperature is, for example, 850° C. to 1000° C. The glass is held at the first treatment temperature for 2 hours to 10 hours, and then, the glass is held at the second treatment temperature for 2 hours to 10 hours.

The glass transition temperature (Tg) of the present glass for strengthening is preferably 480° C. or higher in order to prevent stress relaxation during chemical strengthening. Tg is more preferably 500° C. or higher and still more preferably 520° C. or higher, in order to prevent stress relaxation and obtain a large compressive stress. Tg is preferably 700° C. or lower in order to increase the ion diffusion rate during chemical strengthening. In order to easily obtain deep DOL, Tg is more preferably 650° C. or lower, and still more preferably 600° C. or lower.

The Young's modulus of the present glass for strengthening is preferably 70 GPa or more. As the Young's modulus is increased, broken pieces tend to be less likely to scatter when the strengthened glass is fractured. Therefore, the Young's modulus is more preferably 75 GPa or more, and still more preferably 80 GPa or more. On the other hand, when the Young's modulus is too high, diffusion of ions is slow during chemical strengthening, and it tends to be difficult to obtain deep DOL. Therefore, the Young's modulus is preferably 110 GPa or less, more preferably 100 GPa or less, and still more preferably 90 GPa or less. The Young's modulus can be measured by an ultrasonic method.

The Vickers hardness of the present glass for strengthening is preferably 575 or more. As the Vickers hardness of the glass for chemical strengthening is increased, the Vickers hardness after chemical strengthening tends to increase, and the chemically strengthened glass is less likely to be scratched even when it drops. Therefore, the Vickers hardness of the glass for chemical strengthening is more preferably 600 or more, and still more preferably 625 or more.

Note that the Vickers hardness after chemical strengthening is preferably 600 or more, more preferably 625 or more, and still more preferably 650 or more.

The above range is preferable because scratch hardly occurs as the Vickers hardness is increased. However, the Vickers hardness of the present glass for strengthening is generally 850 or less. If the Vickers hardness of the glass is too high, it tends to be difficult to obtain sufficient ion exchangeability. Therefore, the Vickers hardness is preferably 800 or less, and more preferably 750 or less.

The fracture toughness value of the present glass for strengthening is preferably 0.7 MPa·m^{1/2} or more. As the fracture toughness value is increased, scattering of broken pieces tends to be prevented during fracture of a chemically strengthened glass. The fracture toughness value is more preferably 0.75 MPa·m^{1/2} or more, and still more preferably 0.8 MPa·m^{1/2} or more. The fracture toughness value is generally 1.0 MPa·m^{1/2} or less. The fracture toughness value can be measured by the DCDC method (Acta metall. mater. Vol. 43, pp. 3453-3458, 1995).

The average thermal-expansion coefficient (α) of the present glass for strengthening at 50° C. to 350° C. is preferably 100×10⁻⁷/° C. or less. When the average thermal-expansion coefficient (α) is small, the glass sheet hardly warps during forming of glass or during cooling after chemical strengthening. The average thermal-expansion coefficient (α) is more preferably 95×10⁻⁷/° C. or less, and still more preferably 90×10⁻⁷/° C. or less. In order to prevent warpage of the chemically strengthened glass, the average thermal-expansion coefficient (α) is preferably as small as possible, but is generally 60×10⁻⁷/° C. or more.

For the present glass for strengthening, the temperature (T₂) at which the viscosity becomes 10² dPa·s is preferably 1750° C. or lower, more preferably 1700° C. or lower, and still more preferably 1680° C. or lower. T₂ is generally 1400° C. or higher.

For the present glass for strengthening, the temperature (T₄) at which the viscosity becomes 10⁴ dPa·s is preferably 1350° C. or lower, more preferably 1300° C. or lower, and still more preferably 1250° C. or lower. T₄ is generally 1000° C. or higher.

### EXAMPLES

Hereinafter, the present invention will be described with reference to Examples, but the present invention is not limited thereto.

Glass raw materials were blended in a manner of obtaining the compositions of glass A to E shown in Table 1 in terms of mole percentage based on oxides, and weighed such that the glass has a weight of 400 g. Next, the mixed raw materials were put into a platinum crucible, followed by being put into an electric furnace at 1500° C. to 1700° C., and were melted for about 3 hours, defoamed, and homogenized.

The obtained molten glass was poured into a metal mold, held at a temperature about 50° C. higher than the glass transition point for 1 hour, and then cooled to room temperature at a rate of 0.5° C./min to obtain a glass block. The obtained glass block was cut and ground, and finally both surfaces were mirror-polished to obtain a glass sheet having a thickness of 600 μm. The glass B and the glass D were crystallized under the conditions shown in Table 1 to obtain glass ceramics.

The fracture toughness value, Young's modulus, and CT limit of the obtained glass sheet were measured by the following methods, and the results thereof are shown in Table 1.

### [Fracture Toughness Value]

The fracture toughness value was measured according to a DCDC method by preparing a sample of 6.5 mm×6.5 mm×65 mm. At this time, a through hole having a diameter of 2 mm was formed on a surface of the sample having a size of 65 mm×6.5 mm, and the evaluation was performed.

### [Young's Modulus]

The Young's modulus was measured by an ultrasonic method.

### [CT Limit]

The sheet-shaped glass was chemically strengthened under various conditions using NaNO₃ salt or KNO₃ salt, and the obtained chemically strengthened glass was measured for CT using a scattered light photoelastic stress meter (SLP-1000 manufactured by Orihara Industrial Co., Ltd.). Then, a diamond indenter is driven into chemically strengthened glass sheets having different CT values and a fragmentation number was measured, thereby evaluating the CT limit.

TABLE 1

| mol % | Glass A | Glass B | Glass C | Glass D | Glass E |
|---|---|---|---|---|---|
| SiO₂ | 53.6 | 50.0 | 69.0 | 69.7 | 70.0 |
| Al₂O₃ | 32.1 | 5.0 | 12.4 | 14.6 | 7.5 |
| P₂O₅ | 0.0 | 2.3 | 0.0 | 1.4 | 0.0 |
| Li₂O | 10.7 | 34.1 | 10.8 | 9.6 | 8.0 |
| Na₂O | 0.0 | 1.8 | 4.8 | 2.2 | 5.3 |
| K₂O | 0.0 | 1.2 | 1.2 | 0.0 | 1.0 |
| MgO | 0.0 | 0.0 | 0.1 | 0.0 | 7.0 |
| CaO | 0.0 | 0.0 | 0.1 | 0.0 | 0.2 |
| BaO | 0.0 | 0.0 | 0.0 | 0.4 | 0.0 |
| Y₂O₃ | 3.6 | 1.0 | 1.3 | 0.0 | 0.0 |
| ZrO₂ | 0.0 | 4.5 | 0.3 | 1.2 | 1.0 |
| SnO₂ | 0.0 | 0.0 | 0.0 | 0.9 | 0.0 |
| Crystallization | No | 550° C.-2 hour | No | 750° C.-4 hour | No |
| condition | | ⇒730° C.-2 hour | | ⇒900° C.-4 hour | |
| Fracture | 0.97 | 0.91 | 0.82 | 0.83 | 0.80 |
| toughness value | | | | | |
| (MPa · m^{1/2}) | | | | | |
| Young's modulus | 105 | 105 | 86 | 87 | 83 |
| (GPa) | | | | | |
| CT limit (MPa) | 88 | 81 | 62 | 66 | 57 |

The obtained glass sheets were subjected to a chemical strengthening treatment under the conditions described in Tables 2 and 3 to produce chemically strengthened glasses of Examples 1 to 8 below. The chemical strengthening treatment was performed at the salt, temperature, and time shown in the column of conditions of the first stage chemical strengthening in Tables 2 and 3. Thereafter, chemical strengthening was performed at the salt, temperature, and time shown in the column of conditions of the second stage chemical strengthening in Tables 2 and 3 to obtain chemically strengthened glasses. The obtained chemically strengthened glasses were evaluated according to the following method.

### [Stress Profile]

A stress profile of the obtained chemically strengthened glass was measured according to the following method. As for a surface portion within a depth of 10 μm from a glass surface, glass is immersed in an acid having a volume fraction of 1% HF-99% H₂O in a state in which one surface of the glass is sealed, and only one surface is etched to any thickness. Accordingly, a stress difference occurs between front and back surfaces of the chemically strengthened glass, and the glass warps in accordance with the stress difference. The amount of warpage was measured using a contact type profilometer (Surftest manufactured by Mitutoyo Corporation). The amount of warpage obtained was converted into stress using the formula described in the following document.

Reference document: G. G. Stoney, Proc. Roy. Soc. A, 82 172 (1909).

A portion having a depth of 10 μm or more from the glass surface was measured using a scattered light photoelastic stress meter (SLP2000, manufactured by Orihara Industrial Co., Ltd.).

[Ion Concentration Measurement by EPMA]

The ion concentration of the glass surface was measured using EPMA (JXA-8500F manufactured by JEOL Ltd.). The sample was chemically strengthened, embedded in a resin, and mirror-polished. Since it is difficult to accurately measure the concentration on the outermost surface, the ion concentration of the outermost surface was calculated assuming that the signal intensity of ions at a position where the signal intensity of Si, which is considered to have almost no change in the content, is half the signal intensity of the center portion of the sheet thickness corresponds to the ion concentration of the outermost surface, and assuming that the signal intensity of the central portion of the sheet thickness corresponds to the glass composition before strengthening.

### [Four-Point Bending Strength]

The chemically strengthened glass was processed into a strip shape of 10 mm×50 mm, and was subjected to a four-point bending test under the conditions of a distance between outer fulcrums of a supporting tool of 30 mm, a distance between inner fulcrums of the supporting tool of 10 mm, and a crosshead speed of 0.5 mm/min, and the four-point bending strength was measured. The number of test pieces was 10. The results are shown in Tables 2 and 3.

### [Drop Test]

In the drop test, the obtained glass sample of 120×60×0.6 mmt was fitted into a structure whose mass and rigidity were adjusted according to the size of a typical smartphone currently used, and whereby a pseudo smartphone was prepared. Then, the pseudo smartphone was freely dropped on #180 SiC sandpaper. Regarding the drop height, the pseudo smartphone is dropped from a height of 5 cm and if the glass sample is not cracked, an operation of raising the height by 5 cm and dropping the pseudo smartphone again is repeated until a crack occurs, and an average value of heights of 10 glass samples at which a glass sample cracks for the first time is shown in Tables 2 and 3.

### [Fragmentation Number]

A chemically strengthened glass was processed into a square shape having a side of 30 mm, and a fragmentation test in which a diamond indenter having a tip angle of 90 degrees was driven into the obtained glass was performed. In a case where the glass was not fractured, the test was repeated while gradually increasing a load applied to the indenter, and the number of broken pieces at the minimum load at which the fracture occurred is shown as the fragmentation number in Tables 2 and 3. In a case where the fragmentation number exceeds 10, it can be determined that the internal tensile stress CT is excessive.

The results are shown in Tables 2 and 3. Examples 1 to 6 are Working Examples, and Example 7 is a Comparative Example. In Tables 2 and 3, each notation represents the followings.

CS₀ (MPa): a compressive stress value on the first surface
CSₘ (MPa): a compressive stress value at a depth m [μm] from the first surface
m: a depth (μm) from the first surface at which the compressive stress value is maximum
CS₅₀ (MPa): a compressive stress value at a depth of 50 μm from the first surface
CS₆₀ (MPa): a compressive stress value at a depth of 60 μm from the first surface
DOL (μm): a depth from the first surface at which the compressive stress value is 0
C-0-Li, Na, or K (at %): an ion concentration of Li, Na, or K at a depth of 0 [μm] from the first surface
C-t/2-Li, N a or K (at %): an ion concentration of Li, N a or K at a depth t/2 [μm] from the first surface, where t [μm] is a thickness.

TABLE 2

| | | Example 1 | Example 2 | Example 3 | Example 4 |
|---|---|---|---|---|---|
| Glass composition | | A | B | B | C |
| Conditions of | Molten salt (nitrate) | Na 100 mass % | Na 99.7 mass %, | Na 99.7 mass %, | Na 100 mass % |
| first stage | | | Li 0.3 mass % | Li 0.3 mass % | |
| strengthening | Temperature, time | 450° C., | 450° C., | 450° C., | 450° C., |
| | | 14 hours | 2.4 hours | 2.4 hours | 0.5 hours |
| Conditions of | Molten salt (nitrate) | No | No | No | K 98 mass %, |
| second stage | | | | | Li 2 mass % |
| strengthening | Temperature, time | No | No | No | 450° C., |
| | | | | | 1 hour |

| | | | | |
|---|---|---|---|---|
| Cooling condition | Cooled with water | Cooled with water | Cooled with water | Cooled with water |
| | after being held at | after being held at | after being held at | after being held at |
| | 250° C. for 5 min | 100° C. for 5 min | 250° C. for 5 min | 100° C. for 5 min |
| Sheet thickness (μm) | 700 | 700 | 700 | 700 |
| CS₀ (MPa) | 760 | 530 | 440 | 850 |
| CSₘ (MPa) | 790 | 560 | 550 | 900 |
| CSₘ − CS₀ (MPa) | 30 | 30 | 110 | 50 |
| m (μm) | 1 | 1 | 2 | 2 |
| CS₅₀ (MPa) | 215 | 200 | 210 | 120 |
| CS₆₀ (MPa) | 115 | 135 | 150 | 105 |
| DOL (μm) | 75 | 85 | 90 | 120 |
| C-0-Li (at %) | 4.2 | 20.4 | 20.5 | 3.3 |
| C-0-Na (at %) | 1.5 | 4.0 | 3.9 | 2.8 |
| C-0-K (at %) | 0.0 | 0.1 | 0.1 | 0.9 |
| C-t/2-Li (at %) | 5.7 | 22.5 | 22.5 | 5.7 |
| C-t/2-Na (at %) | 0.0 | 1.2 | 1.2 | 1.3 |
| C-t/2-K (at %) | 0.0 | 0.7 | 0.7 | 0.0 |
| 0.7(C-t/2-Li + C-t/2-Na + C-t/2-K) (at %) | 4.0 | 17.2 | 17.2 | 4.9 |
| Four-point bending test (MPa) | 750 | 530 | 550 | 840 |
| Dropping strength (cm) | 135 | 120 | 130 | 95 |
| Fragmentation number | 6 | 8 | 8 | 7 |

TABLE 3

| | | Example 5 | Example 6 | Example 7 |
|---|---|---|---|---|
| Glass composition | | C | D | E |
| Conditions of | Molten salt (nitrate) | Na 100 mass % | Na 100 mass % | Na 100 mass % |
| first stage | Temperature, time | 450° C., | 420° C., | 450° C., |
| strengthening | | 0.5 hours | 1.25 hours | 4 hours |
| Conditions of | Molten salt (nitrate) | K 98 mass %, | K 99 mass %, | K 100 mass % |
| second stage | | Li 2 mass % | Li 1 mass % | |
| strengthening | Temperature, time | 450° C., | 400° C., | 415° C., |
| | | 1 hour | 1 hour | 2.5 hours |

| | | | |
|---|---|---|---|
| Cooling condition | Cooled with water | Cooled with water | Cooled with water |
| | after being held at | after being held at | after being held at |
| | 250° C. for 5 min | 100° C. for 5 min | 100° C. for 5 min |
| Sheet thickness (μm) | 700 | 700 | 700 |
| CS₀ (MPa) | 800 | 750 | 700 |
| CSₘ (MPa) | 880 | 800 | 700 |
| CSₘ − CS₀ (MPa) | 80 | 110 | 0 |
| m (μm) | 2 | 1 | 0 |
| CS₅₀ (MPa) | 130 | 145 | 102 |
| CS₆₀ (MPa) | 95 | 120 | 80 |
| DOL (μm) | 125 | 120 | 133 |
| C-0-Li (at %) | 3.3 | 3.1 | 2.5 |
| C-0-Na (at %) | 2.8 | 4.1 | 4.2 |
| C-0-K (at %) | 0.9 | 3.0 | 2.5 |
| C-t/2-Li (at %) | 5.7 | 6.6 | 5.2 |
| C-t/2-Na (at %) | 1.3 | 2.9 | 3.4 |
| C-t/2-K (at %) | 0.0 | 0.7 | 0.6 |
| 0.7(C-t/2-Li + C-t/2-Na + C-t/2-K) (at %) | 4.9 | 7.2 | 6.44 |
| Four-point bending test (MPa) | 840 | 760 | 680 |
| Dropping strength (cm) | 95 | 80 | 55 |
| Fragmentation number | 7 | 6 | 7 |

As shown in Tables 2 and 3, it was found that Examples 1 to 6, which were Working Examples, were excellent in strength and were hardly chipped, and broken pieces thereof were prevented from scattering during fracture, as compared with Comparative Examples.

Although the present invention has been described in detail with reference to specific examples, it is apparent to those skilled in the art that it is possible to add various alterations and modifications without departing from the spirit and the scope of the present invention. The present application is based on a Japanese patent application (No. 2020-089755) filed on May 22, 2020, the entire contents of which are incorporated herein by reference. In addition, all references cited here are entirely incorporated.

1. A chemically strengthened glass article comprising:
a first surface;
a second surface facing the first surface; and
an end portion in contact with the first surface and the second surface,
wherein the first surface has a compressive stress value of 400 MPa to 1000 MPa,
wherein, when a compressive stress value of an inside of the glass is expressed with a depth from the first surface as a variable,
a depth m [μm] at which the compressive stress value is maximum is larger than 0 μm, and
a value of CSₘ−CS₀ [MPa] is 30 MPa or more, provided that the compressive stress value at the depth of m [μm] is defined as CSₘ [MPa], and the compressive stress value of the first surface is defined as CS₀ [MPa], and
wherein a depth DOL at which the compressive stress value is 0 is 50 μm to 150 μm.

2. The chemically strengthened glass article according to claim 1, having a compressive stress value CS₆₀ at a depth of 60 μm from the first surface of 100 MPa or more.

3. The chemically strengthened glass article according to claim 1, wherein the value of CSₘ−CS₀ [MPa] is 300 MPa or less.

4. The chemically strengthened glass article according to claim 1, wherein the depth m [μm] at which the compressive stress value is maximum is 5 μm or less.

5. The chemically strengthened glass article according to claim 1, comprising a lithium aluminosilicate glass.

6. The chemically strengthened glass article according to claim 5, comprising a glass ceramic.

7. The chemically strengthened glass article according to claim 6, having a base glass of the chemically strengthened glass comprising, in terms of mol % based on oxides:
SiO₂ in an amount of 40% to 75%,
Al₂O₃ in an amount of 2% to 20%,
Li₂O in an amount of 4% to 35%, and
ZrO₂+TiO₂+SnO₂ in a total amount of 1% to 7%.

8. The chemically strengthened glass article according to claim 5, having a base glass, that is an amorphous glass, of the chemically strengthened glass comprising, in terms of mol % based on oxides:
SiO₂ in an amount of 40% to 65%,
Al₂O₃ in an amount of 15% to 35%,
Li₂O in an amount of 4% to 15%, and
Y₂O₃+La₂O₃ in a total amount of 1% to 15%.

9. The chemically strengthened glass article according to claim 5, having a base glass, that is an amorphous glass, of the chemically strengthened glass comprising, in terms of mol % based on oxides:
SiO₂ in an amount of 60% to 75%,
Al₂O₃ in an amount of 8% to 20%,
Li₂O in an amount of 5% to 20%, and
Na₂O+K₂O in a total amount of 1% to 15%.

10. The chemically strengthened glass article according to claim 5, satisfying the following expressions:
Li(0)≤Li(t/2);
K(0)≤K(t/2);
Na(0)>0.3×[Li(0)+Na(0)+K(0)]; and
Li(t/2)>0.7×[Li(t/2)+Na(t/2)+K(t/2)],
provided that a thickness of the chemically strengthened glass article is defined as t [μm], and ion concentrations of Li, Na, and K at a depth x [μm] from the first surface are defined as Li(x), Na(x), and K(x).

11. A method for producing a chemically strengthened glass article, the method comprising:
immersing a lithium aluminosilicate glass into a salt at 400° C. to 450° C. comprising 90 mass % or more of sodium nitrate; and
taking out the lithium aluminosilicate glass from the salt, and then holding the lithium aluminosilicate glass at 100° C. to 300° C. for 1 minute or more.

12. The method for producing a chemically strengthened glass article according to claim 11, wherein the lithium aluminosilicate glass comprises, in terms of mol % based on oxides, SiO₂ in an amount of 40% to 75%, Al₂O₃ in an amount of 2% to 35%, and Li₂O in an amount of 4% to 35%.

13. The method for producing a chemically strengthened glass article according to claim 11, wherein the salt comprises lithium ions in an amount of 2 mass % or less.
